(19) United States
(12) Patent Application Publication
(10) Pub. No.: US 2011/0171546 A1
(43) Pub. Date: Jul. 14, 2011

(54) Solid Oxide Fuel Cell System

(75) Inventors: Wen-Tang Hong, Caotun Township (TW); Yu-Ching Tsai, Donggang Township (TW); Hung-Yu Wang, Jhonghe City (TW); Tzu-Hsiang Yen, Yongkang City (TW); Wei-Ping Huang, Longtan Township (TW); Chien-Hsiung Lee, Longtan Township (TW); Cheng-Nan Huang, Longtan Shiang (TW); Ming-Dar Lin, Yangmei Township (TW); Chen-Po Lai, Hukou Township (TW)

(73) Assignee: ATOMIC ENERGY COUNCIL-INSTITUTE OF NUCLEAR ENERGY RESEARCH, Taoyuan County (TW)

(21) Appl. No.: 12/685,297

(22) Filed: Jan. 11, 2010

(51) Int. Cl. H01M 8/04

(52) U.S. Cl. 429/420; 429/434

(57) ABSTRACT

A solid oxide fuel cell system includes a fuel cell unit for generating electricity via executing an electrochemical reaction on fuel, a fuel supply for storing the natural gas, water and air and a re-composing unit for re-composing natural gas, water and air into the fuel. A pipe transfers the natural gas, water and air into the re-composing unit from the fuel supply. Another pipe transfers the fuel into the fuel cell unit from the re-composing unit. Another pipe transfers hot air into the re-composing unit from the fuel cell unit. A mixing unit mixes air with residual fuel from the fuel cell unit. A combusting unit burns the mixture from the mixing unit. A heat-exchanging unit executes heat-exchanging between air and the exhaust from the combusting unit. The heat-exchanging unit includes an air-inletting port, an exhaust port and another port for sending hot air into the fuel cell unit.

### FIELD OF INVENTION

The present invention relates to a solid oxide fuel cell and, more particularly, to a solid oxide fuel cell system for generating electricity by executing electrochemical reaction on fuel and burning residual fuel.

### BACKGROUND OF INVENTION

The prices of energy sources are skyrocketing. Hence, it is important to increase the efficiencies of using the energy sources.

Disclosed in US Patent Publication 2004/0247961 is an auxiliary fuel cell system adapted to supplement a primary power source normally adapted to provide power to an energy-consuming system responsive to an applied load from the energy-consuming system. The auxiliary fuel cell system includes a power delivery subsystem adapted to selectively provide power to an energy-consuming system responsive at least in part to an applied load from the energy-consuming system. The power delivery subsystem includes a source subsystem, at least one fuel cell stack, an energy storage subsystem and a source-selection subsystem. The source subsystem is adapted to provide fuel and oxidant. The fuel cell stack is adapted to produce an electric current from fuel and oxidant received from the source subsystem. The energy storage subsystem is adapted to receive at least a portion of the electric current from the at least one fuel cell stack. The source-selection subsystem is adapted to selectively enable and disable power linkages between the auxiliary fuel cell system and the primary power source relative to the energy-consuming system to selectively regulate which of the auxiliary fuel cell system and the primary power source is currently configured to provide power to satisfy an applied load from the energy-consuming system.

However, fuel is not fully used to generate electricity in the auxiliary fuel cell system. That is, there is residual fuel released without being used. Hence, the efficiency of the operation of the auxiliary fuel cell system is inadequate.

The present invention is therefore intended to obviate or at least alleviate the problems encountered in prior art.

### SUMMARY OF INVENTION

It is the primary objective of the present invention to provide a solid oxide fuel cell system.

According to the present invention, the solid oxide fuel cell system includes a fuel cell unit for generating electricity via executing an electrochemical reaction on fuel, a fuel supply for storing the natural gas, water and air and a re-composing unit for re-composing natural gas, water and air into the fuel. A pipe transfers the natural gas, water and air into the re-composing unit from the fuel supply. Another pipe transfers the fuel into the fuel cell unit from the re-composing unit. Another pipe transfers hot air into the re-composing unit from the fuel cell unit. A mixing unit mixes air with residual fuel from the fuel cell unit. A combusting unit burns the mixture from the mixing unit. A heat-exchanging unit executes heat-exchanging between air and the exhaust from the combusting unit. The heat-exchanging unit includes an air-inletting port, an exhaust port and another port for sending hot air into the fuel cell unit.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a front view of a solid oxide fuel cell system according to the preferred embodiment of the present invention.

FIG. 2 is a block diagram of the solid oxide fuel cell system shown in FIG. 1.

FIG. 3 is a perspective view of the solid oxide fuel cell system shown in FIG. 1.

### DETAILED DESCRIPTION OF PREFERRED EMBODIMENT

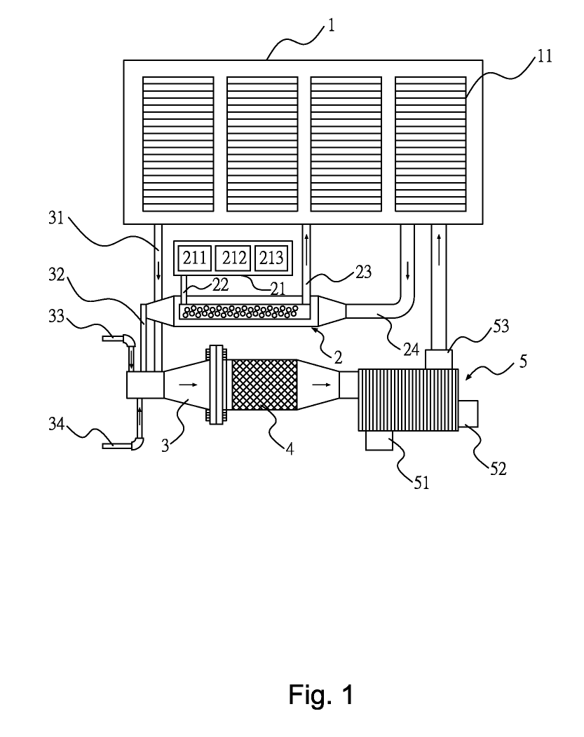

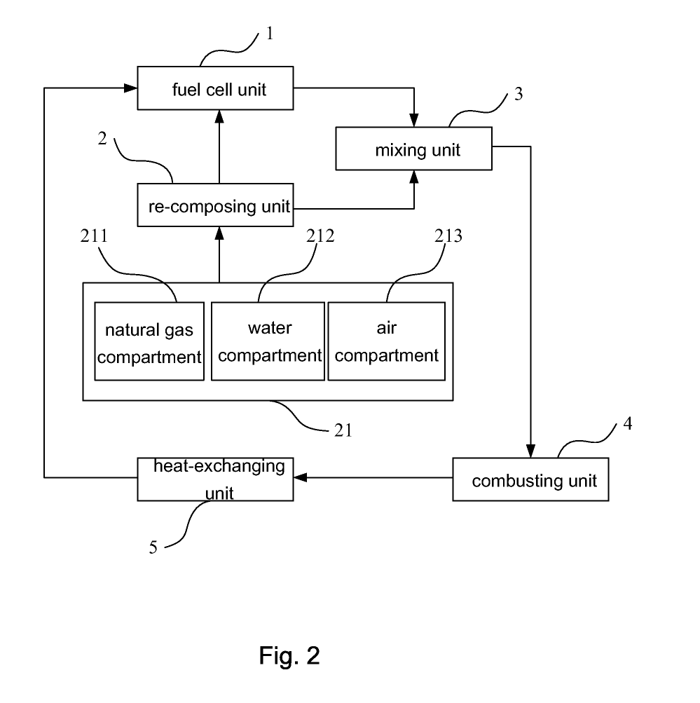

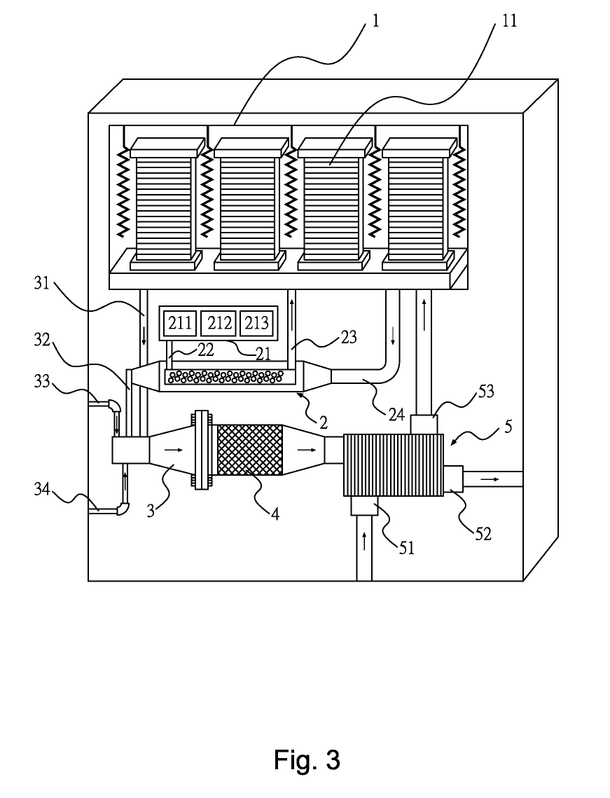

Referring to FIGS. 1 through 3, a solid oxide fuel cell system includes a fuel cell unit 1, a re-composing unit 2, a mixing unit 3, a combusting unit 4 and a heat-exchanging unit 5 according to the preferred embodiment of the present invention. The fuel cell unit 1 includes cell piles 11 to generate electricity via executing an electrochemical reaction.

The re-composing unit 2 includes a fuel supply 21, a pipe 22 for connecting the fuel supply 21 to the mixing unit 3, a pipe 23 for connecting the fuel supply 21 to the fuel cell unit 1 and a pipe 24 for connecting the fuel supply 21 to the fuel cell unit 1. The fuel supply 21 includes a natural gas compartment 211, a water compartment 212 and an air compartment 213.

The mixing unit 3 is connected to the fuel cell unit 1 via a pipe 31. The mixing unit 3 is connected to the re-composing unit 2 via a pipe 32. Fuel can be transferred into the mixing unit 3 through a pipe 33. Fuel can be transferred into the mixing unit 3 through another pipe 34.

The combusting unit 4 is connected to mixing unit 3.

The heat-exchanging unit 5 is connected to the combusting unit 4. Air can be transferred into the heat-exchanging unit 5 through a port 51. Exhaust can be expelled from the heat-exchanging unit 5 through another port 52. The heat-exchanging unit 5 is connected to the fuel cell unit 1 through a port 53.

In operation, fuel is transferred into the re-composing unit 2 from the natural gas compartment 211 of the fuel supply 21. Water is transferred into the re-composing unit 2 from the water compartment 212 of the fuel supply 21. Air is transferred into the re-composing unit 2 from the air compartment 213 of the fuel supply 2. The natural gas, water and air are re-composed into hydrogen-rich gas in the re-composing unit 2. The hydrogen-rich gas is transferred into the fuel cell unit 1 from the re-composing unit 2 through the pipe 23. The hydrogen-rich gas is used as fuel. An electrochemical reaction is executed on the hydrogen-rich gas in the fuel cell unit 1. However, there is left some of the fuel, residual fuel.

The residual fuel is transferred into the mixing unit 3 from the anode of the fuel cell unit 1 through the pipe 31. Hot gas is transferred to the re-composing unit 2 from the cathode of the fuel cell unit 1 through the pipe 24. The heat of the hot gas is reused in the re-composing unit 2. Then, the hot gas is the mixing unit 3 from the re-composing unit 2 through the pipe 32. The residual fuel is mixed with the hot gas in the mixing unit 3.

The mixture is transferred into the combusting unit 4 from the mixing unit 3. The mixture is combusted in the combusting unit 4. Air can be transferred into the mixing unit 3 through the pipe 33 to control the temperature of the mixing unit 3 to avoid the combustion of the mixture in the mixing unit 3. Fuel can be transferred into the mixing unit 3 through the pipe 34 to control the temperature in the combusting unit 4 after the combustion of the mixture.

Exhaust is sent into the heat-exchanging unit 5 from the combusting unit 4. Fresh air is transferred into the heat-exchanging unit 5 through the port 51. Heat-exchanging is executed between the exhaust and the fresh air in the heat-exchanging unit 5. The exhaust is expelled from the heat-exchanging unit 5 through the port 52. Hot air is transferred into the cathode of the fuel cell unit 1 from the heat-exchanging unit 5 through the port 53.

As discussed above, in the fuel cell unit 1, the electrochemical reaction of the hydrogen-rich gas produced with the re-combining unit 2 generates electricity. In the heat-exchanging unit 5, the heat-exchanging between the exhaust released from the combusting unit 4 and the fresh air recycles the heat for use in the fuel cell unit 1 to generate more electricity. Therefore, the efficiency of the solid oxide fuel cell system is high.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A solid oxide fuel cell system comprising:
a fuel cell unit for generating electricity via executing an electrochemical reaction on fuel;
a fuel supply for storing the natural gas, water and air;
a re-composing unit for re-composing natural gas, water and air into hydrogen-rich gas used as the fuel;
a first pipe for transferring the natural gas, water and air into the re-composing unit from the fuel supply;
a second pipe for transferring the fuel into the fuel cell unit from the re-composing unit;
a third pipe for transferring hot air into the re-composing unit from the fuel cell unit;
a mixing unit for mixing air with residual fuel from the fuel cell unit;
a combusting unit for combusting the mixture from the mixing unit; and
a heat-exchanging unit for executing heat-exchanging between air and the exhaust from the combusting unit, the heat-exchanging unit comprising a first port for inletting the air, a second port for expelling the exhaust and a third port for sending hot air into the fuel cell unit.

2. The solid oxide fuel cell system according to claim 1, wherein the fuel cell unit comprises cell piles.

3. The solid oxide fuel cell system according to claim 1, wherein the fuel supply comprises a natural gas compartment, a water compartment and an air compartment.

4. The solid oxide fuel cell system according to claim 1 comprising a fourth pipe for transferring the residual fuel into the mixing unit from the fuel cell unit and a fifth pipe for transferring the hot air into the mixing unit from the re-composing unit.

5. The solid oxide fuel cell system according to claim 4 comprising a sixth pipe for transferring air into the mixing unit and a seventh pipe for transferring fuel into the mixing unit.
